(19) United States
(12) Patent Application Publication
(10) Pub. No.: US 2006/0202820 A1
(43) Pub. Date: Sep. 14, 2006

(54) Wireless Temperature and Pressure Sensor for High Voltage Applications

(76) Inventors: Robert J. Schwabe, Katonah, NY (US); Shalom Zelingher, Hartsdale, NY (US)

Correspondence Address: BOND, SCHOENECK & KING, PLLC, ONE LINCOLN CENTER, SYRACUSE, NY, 13202-1355, US

(21) Appl. No.: 11/307,679

(22) Filed: Feb. 16, 2006

Related U.S. Application Data
(60) Provisional application No. 60/653,321, filed on Feb. 16, 2005.

(51) Int. Cl. G08B 1/08; H04Q 9/00; G08B 19/00

(52) U.S. Cl. 340/539.22; 340/870.07; 340/521

(57) ABSTRACT

A remote monitoring system provides monitoring of basic parameters of substation equipment. Remote sensor transmitter units are mounted directly on live high voltage parts of substation equipment, and take measurements of basic parameters such as temperature and pressure. The resulting data is broadcast by wireless (radio) communications to a ground based receiver. The data is then transmitted to a central data collection computer for further processing and analysis. A large substation may utilize hundreds of remote sensor transmitter units and several ground based receivers to gain the desired coverage.

### CROSS-REFERENCE TO RELATED APPLICATION

The present application claims priority to U.S. Provisional Application Ser. No. 60/653,321, filed Feb. 16, 2005.

### BACKGROUND OF THE INVENTION

The present invention relates generally to power line monitoring equipment, and more particularly to the monitoring and wireless reporting of the basic parameters of substation equipment.

A substation is a high-voltage electric system facility. It is used to switch generators, equipment, and circuits or lines in and out of a system. It also is used to change AC voltages from one level to another, and/or change alternating current to direct current or direct current to alternating current. Some substations are small with little more than a transformer and associated switches. Others are very large with several transformers and dozens of switches and other equipment.

Substations sometimes malfunction or fail as a result of a component failure. When failure occurs, an electrical grid can fail to distribute power, creating potentially devastating consequences for those serviced by the grid. In addition, repair and maintenance of the substation and associated equipment is expensive.

Often times the failure occurs as a result of a temperature or pressure spike occurring on a particular piece of equipment.

It is therefore a principal object and advantage of the present invention to provide a sensor and monitoring system for high voltage equipment.

It is therefore a principal object and advantage of the present invention to provide a sensor and monitoring system for high voltage equipment.

It is another object and advantage to provide sensor and monitoring equipment that does not affect the high voltage performance or the current carrying capacity of the equipment.

It is a further object and advantage of the present invention to provide a sensor and monitoring system that can be customized for a particular application.

It is yet an additional object and advantage of the present invention to provide a sensor and monitoring system that monitors the conditions of potentially hundreds of pieces of equipment within a substation yard.

Other objects and advantages of the present invention will in part be obvious, and in part appear hereinafter.

### SUMMARY OF THE INVENTION

In accordance with the foregoing objects and advantages, the present invention provides a system for monitoring basic parameters of substation equipment. Remote sensor transmitter units are mounted directly on live high voltage parts of substation equipment, and take measurements of basic parameters such as temperature and pressure. The resulting data is broadcast by wireless (radio) communications to a ground based receiver. The data is then transmitted to a central data collection computer for further processing and analysis. A large substation may utilize hundreds of remote sensor transmitter units and several ground based receivers to gain the desired coverage.

### BRIEF DESCRIPTION OF THE DRAWINGS

The present invention will be more fully understood and appreciated by reading the following Detailed Description in conjunction with the accompanying drawings, in which:

FIG. 1 is a schematic representation of the wireless sensor system of the present invention;

FIG. 2 is an electrical schematic of the sensor transmitter unit;

FIG. 3-7 are perspective views at different orientations of the sensor transmitter assembly;

FIGS. 8-10 are sample graphs that can be created by analyzing the gathered data.

FIG. 11 is a schematic representation of a mapping operation when the system is used in an alternate mode of operation;

FIG. 12 is a plan view of a battery/switch module applied when using the system in an alternate mode of operation;

FIG. 13 is a perspective view of a battery/switch module connected to a sensor;

FIG. 14 is an exploded perspective view of a battery/switch module shown in spaced relation to a sensor;

FIG. 15 is a perspective view of a sensor used when the system is operated in an alternate mode; and

FIG. 16 is a front elevation view of a hand held signal strength meter used when operating the system in an alternate mode.

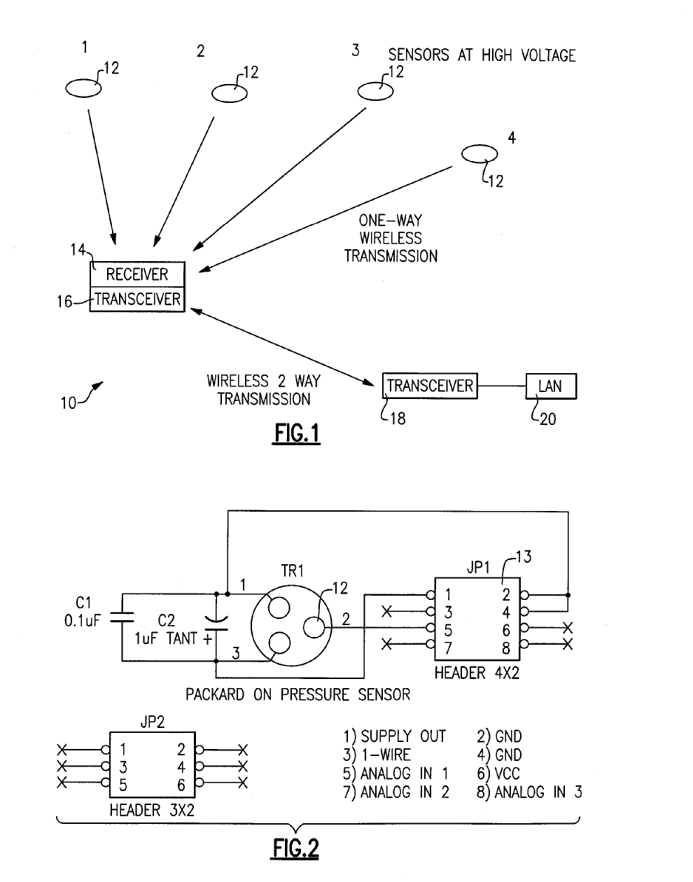

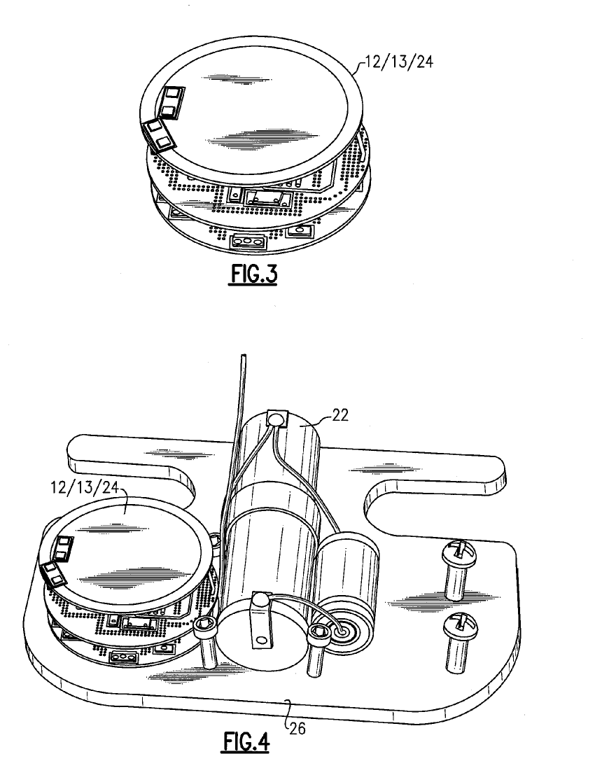

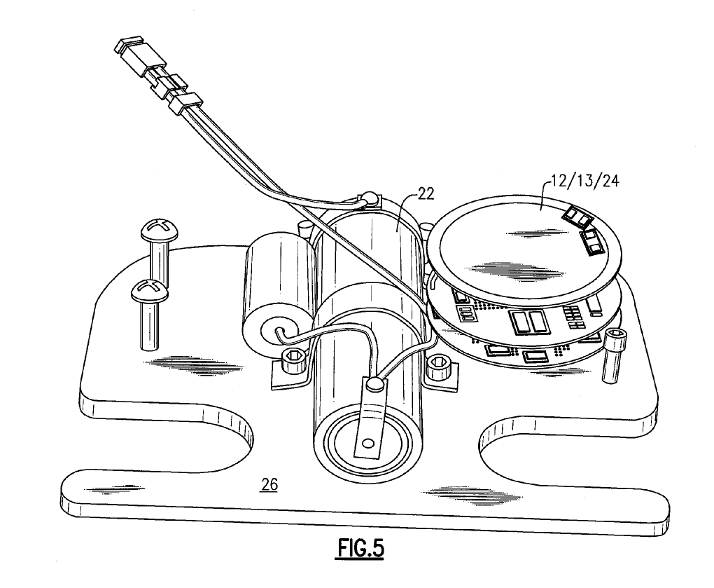

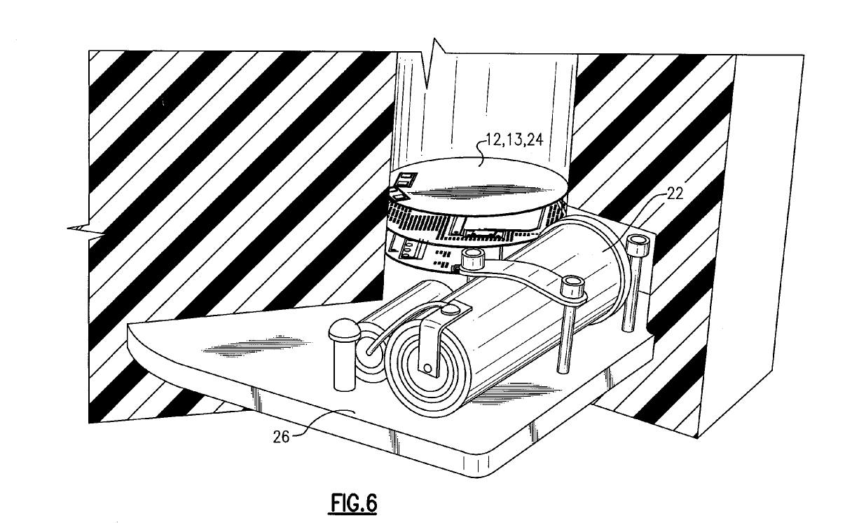

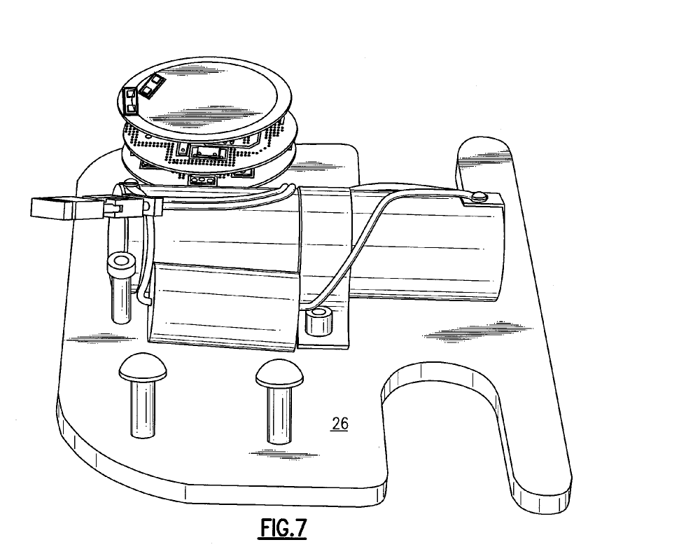

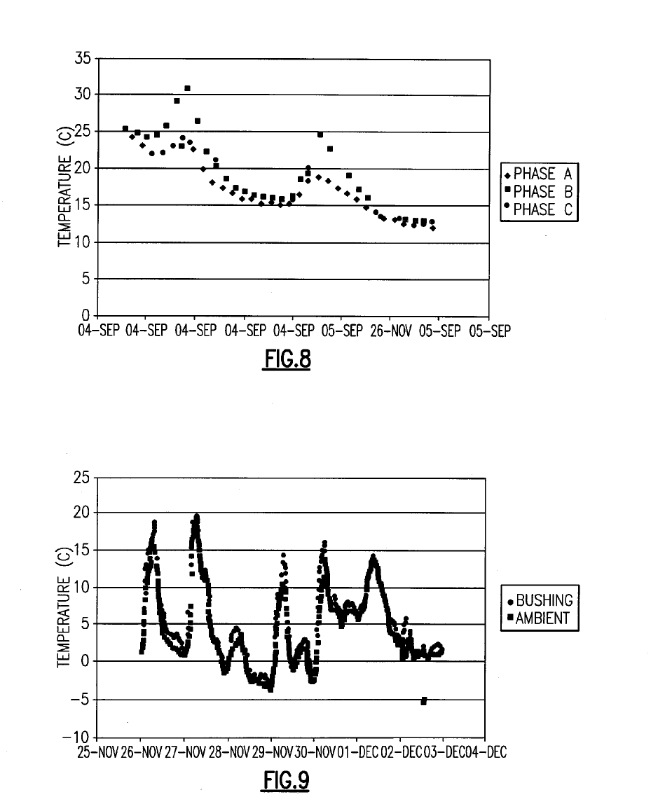

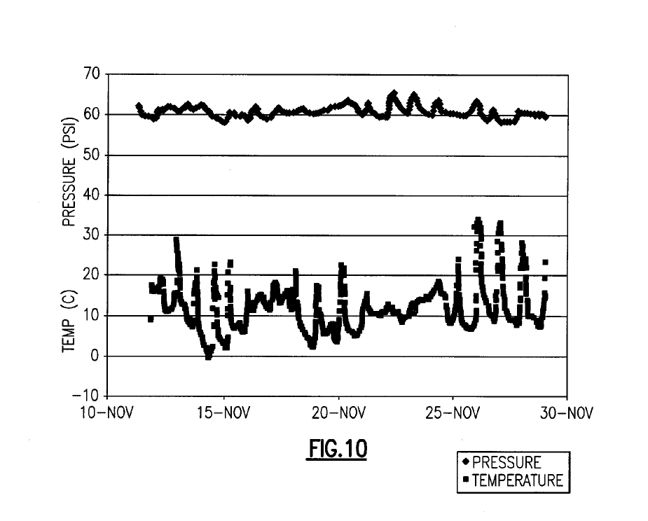

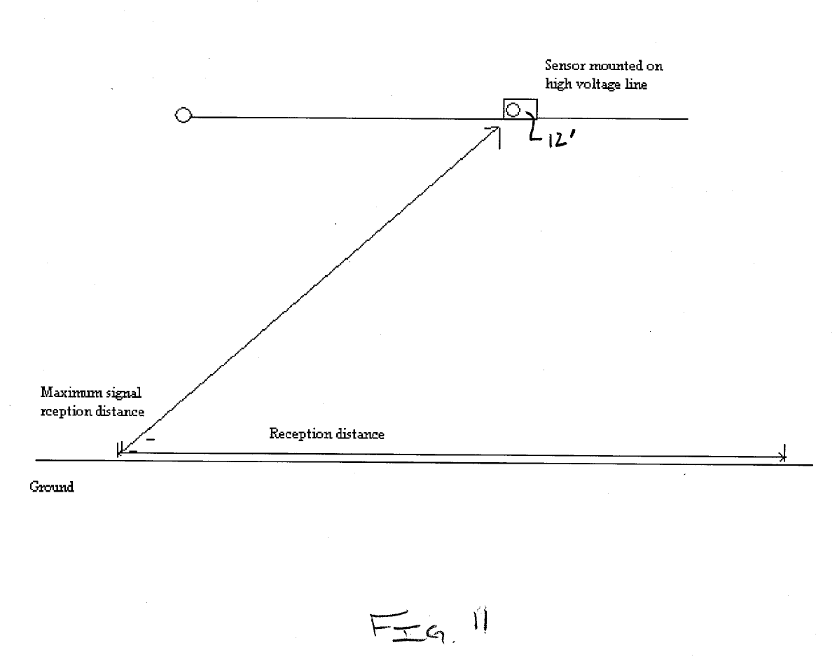

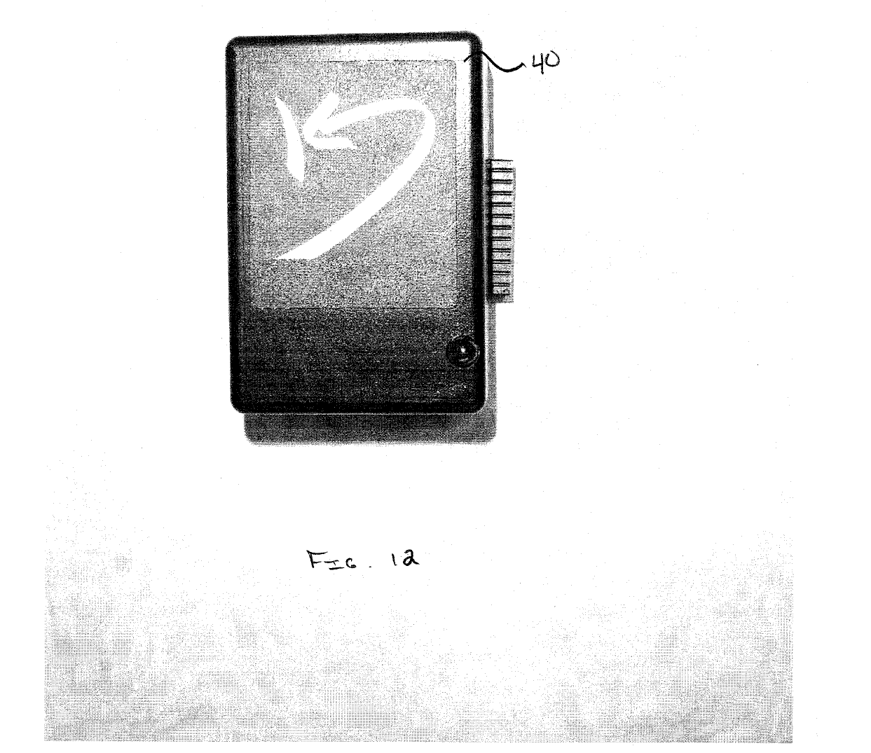

### DETAILED DESCRIPTION

Referring now to the drawings in which like reference numerals refer to like parts throughout, there is seen in Figures a remote condition monitoring system designated generally by reference numeral 10 essentially comprising a plurality of sensors 12 mounted on high voltage lines (e.g., up to 765 kV), a sensor transmitter 13, a ground based receiver 14 for receiving packets of sensor data for sensor transmitter 13 at predetermined intervals, a ground based transceiver 16 for transmitting sensor data and receiving prompts from a transceiver 18 that is interconnected to a network of computers 20 for processing and analyzing the sensor data. Sensors 12 comprise active temperature and pressure sensors to monitor those basic parameters of the high voltage equipment to which they are attached, such as circuit breakers, disconnects, potheads, switcher circuits, capacitor banks, various types of transformers, lightning arresters, bus support insulators, and the like, all of which are well known to those skilled in the art.

Sensors 12 are attached to live high voltage components and are packaged together with a battery/power source 22 that preferably provides for 5 to 10 years of unattended, maintenance free operation, and with an antenna 24. This collection of components is designed to not interfere with the high voltage performance or current carrying capability of the substation equipment.

The temperature and pressure data collected by sensors 12 is transmitted in packets by transmitter 13 to receiver 14 at predetermined intervals. The interval at which data packets are transmitted is configured at the time of assembly, but may optionally be selectable by the user. As receiver 14 may receive data packets from many different sensors 12 (sensors 12 mounted on various equipment within a substation yard), each packet is identified by an ID associated with the particular sensor 12. In addition, it may be necessary to utilize several ground based receivers 13 to gain the desired coverage within a particular substation. Regardless, data from many sensors 12 can be organized and managed by receiver 14 due to the use of IDs (and ultimately by data collection computers associated with network 20.)

Transmitter 13 receives and transmits data collected by sensors 12. It is contemplated that more than just temperature and pressure may be desired for certain applications, and therefore transmitter 13 has been designed to include several unused analog inputs and a digital data bus to interface with additional external sensors. Temperature and pressure sensors 12 can be either on-board or external to transmitter 13. In addition, it is preferred that transmitter 13 transmit in the 900 MHz unlicensed band at a rate of 1 data packet per interval (every 15, 30, 45, 60 minutes, for instance.)

Sensors 12, transmitter 13, and batteries 22 are mounted on a plate 26 that can be effectively attached to high voltage equipment. The transmitter has been designed with an antenna that permits optimization of its and ground receiver 14 placement.

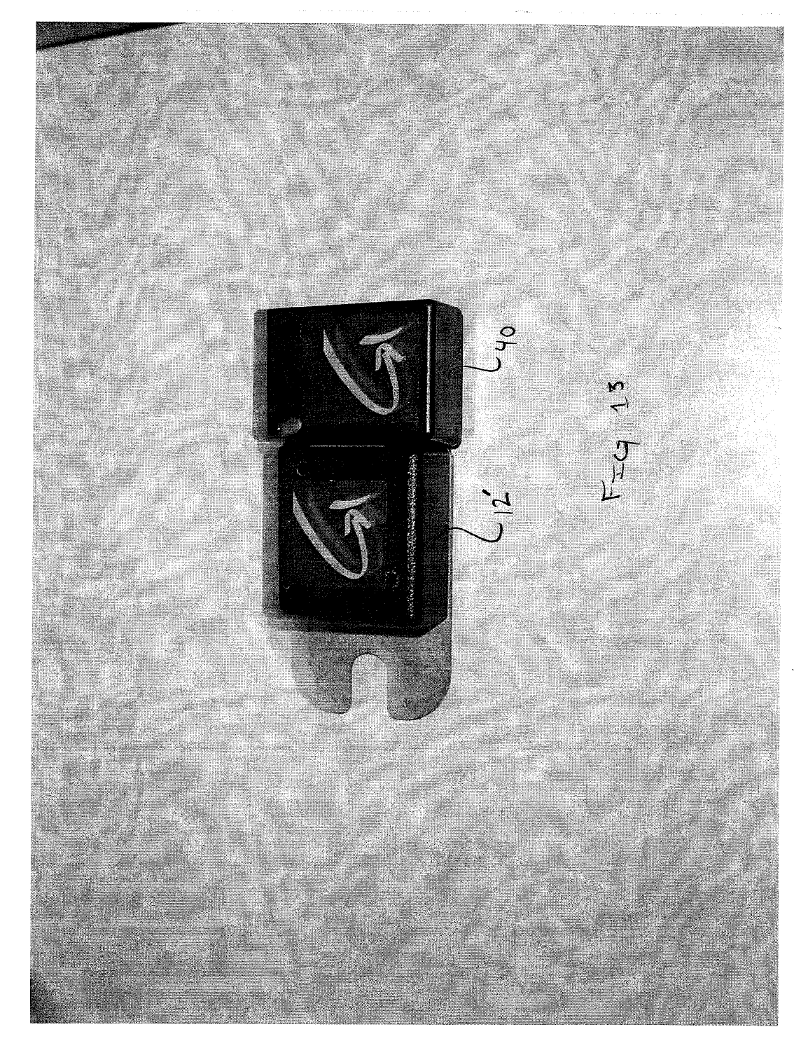

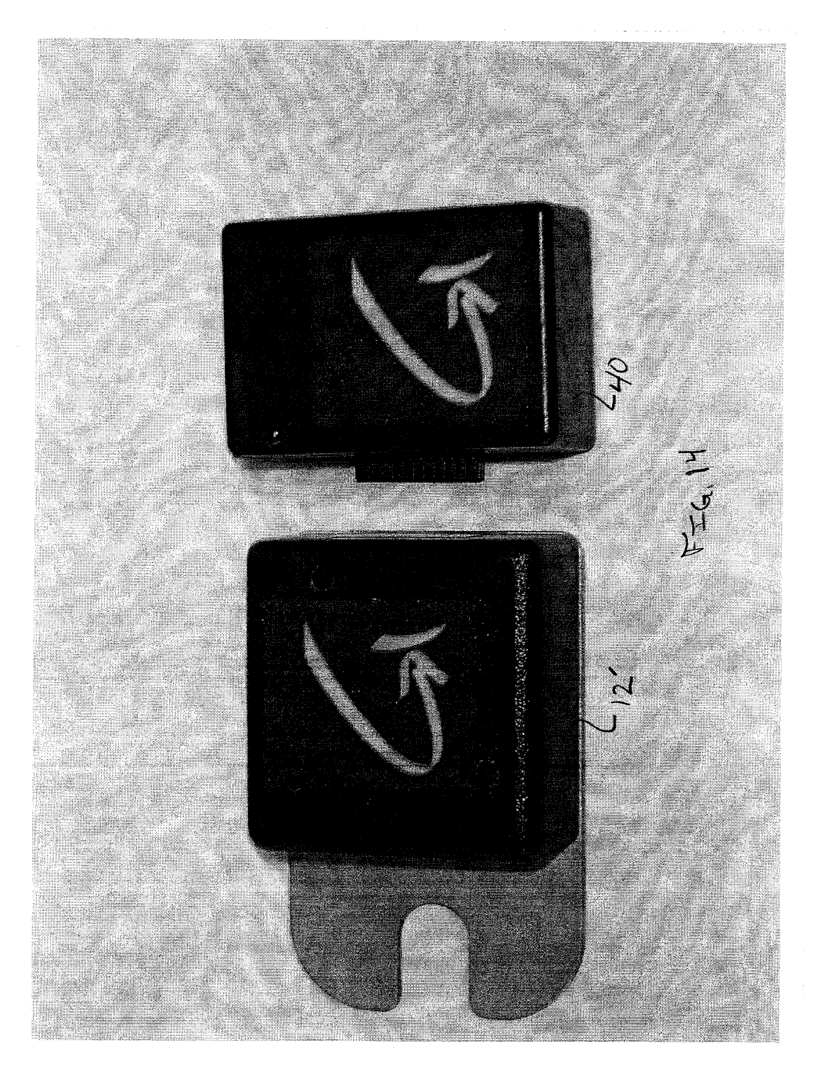

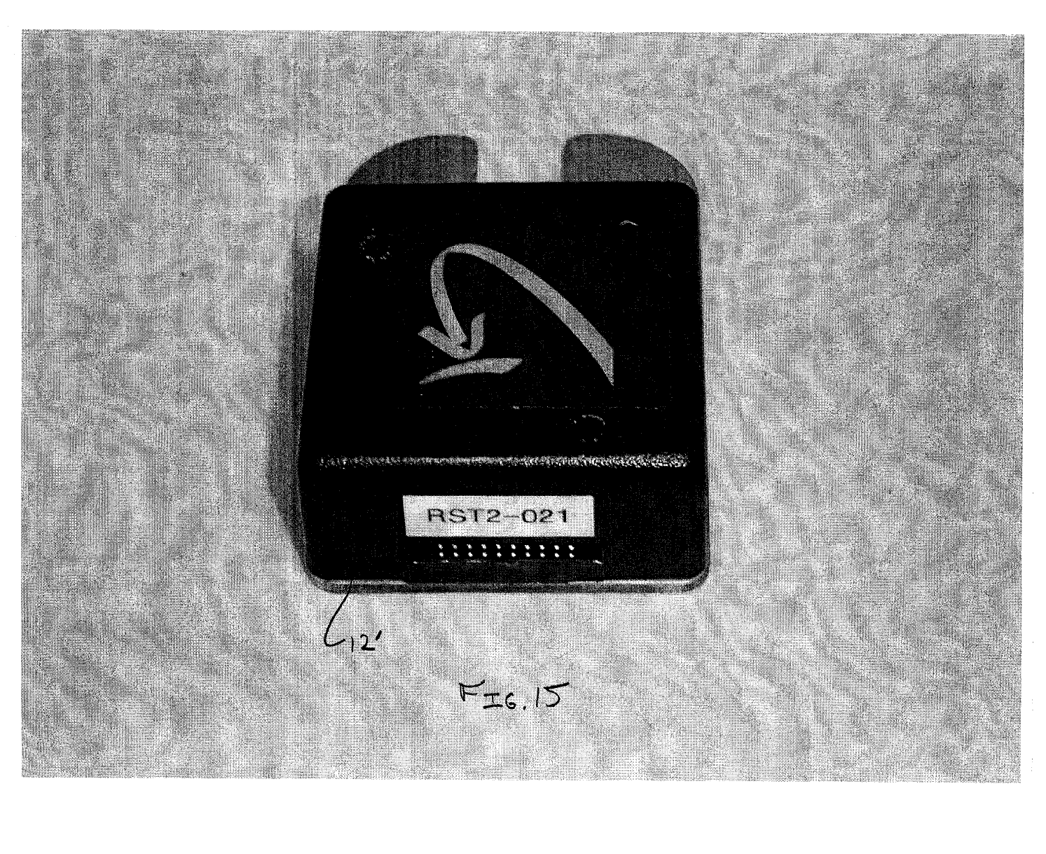

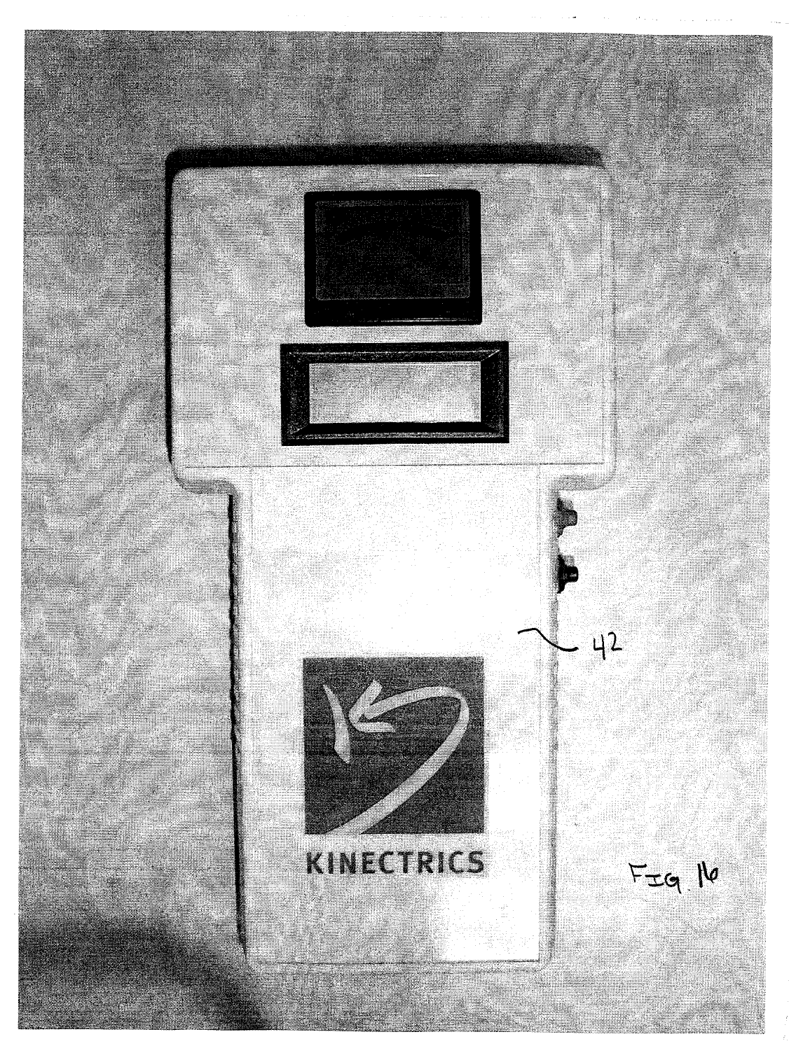

In an alternate mode of operation (and with reference to FIGS. 11-16), an external battery/switch module 40 is electrically connected to sensor 12′ at the time of installation, and provides for a continuous RF transmission rate. Battery module 40 connects to sensor 12′ and switches the operation to a continuous transmission rate. A hand held signal strength meter 42 (see FIG. 16) tuned to the transmission frequency is then used to map the maximum distance on the ground from sensor 12′ that the signal can be received by receiver 14, as illustrated in FIG. 11. Following the mapping, module 40 is disconnected from sensor 12′ which then switches back to its normal mode of operation. This process could be done for each sensor 12′ independently. The final mapping for all sensors thus permits optimization of the positioning of ground base receiver/transmitter 14/16.

What is claimed is:

1. A system for monitoring physical conditions associated with a substation, comprising:
a. a plurality of condition sensors adapted for monitoring predetermined parameters of high voltage equipment on which each is adapted for mounting;
b. a plurality of first transmitters each of which is associated with a corresponding one of said plurality of condition sensors, wherein each first transmitter is adapted to transmit data signals at predetermined intervals, each of said data signals being representative of its associated sensor's predetermined parameter;
c. a receiver remotely positioned relative to said plurality of first transmitters and predetermined sensors and being adapted to receive data transmissions sent from said plurality of transmitters;
d. a second transmitter associated with said receiver and adapted to transmit said data signals received by said receiver; and
e. a computer adapted to receive and process said data signals in a predetermined manner.

2. The monitoring system of claim 1, wherein said condition sensors are selected from the group of sensors including pressure sensors and temperature sensors.

3. The monitoring system of claim 1, wherein said high voltage equipment is selected from the group including circuit breakers, disconnects, potheads, switcher circuits, capacitor banks, transformers, lightening arresters, and bus support insulators.

4. The monitoring system of claim 1, further comprising a power supply connected to said sensors.

5. The monitoring system of claim 4, wherein said power supply comprises batteries.

6. The monitoring system of claim 1, wherein each of said data signals transmitted by said first plurality of transmitters comprises a packet of data with each or said packets including a unique identifier.

7. The monitoring system of calm 6, wherein each of said packets corresponds with a known one of said plurality of sensors.

8. The monitoring system of claim 7, wherein each of said first transmitters is adapted to transmit at about 900 MHz at a rate of one of said data packets per predetermined interval.

9. The monitoring system of claim 8, wherein said predetermined interval is configured at the time of assembly of each said first transmitter.

10. A high voltage equipment monitoring package, comprising:
a. a sensor adapted to monitor a predetermined parameter of the high voltage equipment;
b. a transmitter operatively coupled to said sensor and adapted to wirelessly transmit a data signal representative of said predetermined parameter; and
c. a power source adapted to provide power to said sensor and said transmitter.

11. The high voltage equipment monitoring package of claim 10, wherein said sensor is adapted to monitor a parameter from the group including temperature and pressure.

12. The high voltage equipment monitoring package of claim 10, herein each of said data signals transmitted by said transmitter comprises a packet of data with its own unique identifier.

13. The high voltage equipment monitoring package of claim 12, wherein said transmitter is adapted to transmit at about 900 MHz at a rate of one of said data packets per predetermined interval.

14. The high voltage equipment monitoring package of claim 10, wherein said power supply comprises a battery.

15. A method for monitoring a predetermined parameter of high voltage equipment, comprising the steps of:
a. mounting a sensor on the high voltage equipment, said sensor being adapted to monitor and collect data regarding the predetermined parameter of the high voltage equipment;
b. transmitting said data collected by said sensor to a remotely positioned receiver;
c. transmitting said data received by said remote receiver to a remotely positioned computer; and
d. processing said data at said computer.

16. The method for monitoring a predetermined parameter of high voltage equipment according to claim 15, and following the step of mounting a sensor on the high voltage equipment, comprising the further step of collecting and packaging a predetermined amount of said data in a packet having a unique identifier.

17. The method for monitoring a predetermined parameter of high voltage equipment according to claim 16, comprising the step of transmitting said packet at about 900 MHz and at a rate of one of said data packets per predetermined interval.

18. The method for monitoring a predetermined parameter of high voltage equipment according to claim 17, wherein said predetermined interval is set by a user.
